(19) United States
(12) Patent Application Publication
(10) Pub. No.: US 2009/0140479 A1
(43) Pub. Date: Jun. 4, 2009

(54) VARIABLE COMPLIANCE SUSPENSION BUSHING

(76) Inventors: Jon E. Markoski, Canton, MI (US); Stewart Snead, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/327,236

(22) Filed: Dec. 3, 2008

Related U.S. Application Data
(60) Provisional application No. 60/991,802, filed on Dec. 3, 2007.

(51) Int. Cl. F16F 13/04

(52) U.S. Cl. 267/140.12

(57) ABSTRACT

A variable compliance bushing including means to selectively vary the stiffness of the connection between the parts joined by the bushing and especially suitable in vehicle suspension systems where the stiffness of the connection can be varied depending on road conditions or the like to provide better handling and rider comfort.

### CROSS-REFERENCE TO RELATED APPLICATIONS

This application claims the benefit of Provisional Application 60/991,802 filed Dec. 3, 2007, which is incorporated herein by reference.

### BACKGROUND OF THE INVENTION

In a motor vehicle suspension, bushings are used to connect various moving arms and pivot points to the vehicle's chassis and/or other parts of the suspension. To dampen vibrations between the connected parts bushings typically take the form of an annular cylinder of flexible material formed inside a metallic housing or outer tube. The bushing housing is mounted to one of the parts to be joined and the other part in the form of a cylindrical bar or the like extends through the cylinder of flexible material. The combination of the outer metallic housing or tube, and the inner flexible material provides dampening of vibration from the inner metal element to the outer housing and vice versa. As such, bushings as used in vehicles are dynamic components, in that they operate while the motor vehicle is in motion and seek to minimize vibration, wear and transmission of noise from the road to the vehicle. They typically include a flexible component usually constructed of rubber or polyurethane.

Some bushings can have “voids” or chambers which provide softer rates of dampening until the bushing is moved to a position where the void is closed, thereby allowing the bushing to build or provide a higher stiffness or rate of dampening. This type of bushing creates a two-staged effect, one stage being a soft rate while working in the position where the void is open, and another stage having a stiffer rate when the void is completely closed. Although the bushings with voids provide a two-staged dampening effect, a more continuous variation in the stiffening and/or dampening rate of the bushing and a means to control the rate of dampening effect over the entire range between a high degree of stiffness to a low degree would be desirable in many applications. Such a variable compliance bushing would be especially desirable in vehicle applications by providing for instance an improved suspension system that could adapt to a multitude of different road conditions.

### SUMMARY OF THE INVENTION

The present invention provides a bushing which includes means to selectively vary the stiffness provided between the joined parts and which can be installed in the suspension system on a vehicle chassis in place of a conventional rubber metal bushing. The bushing of the present invention includes a pair of spaced voids or chambers. Hydraulic pressure applied to the chambers varies the stiffness of the bushing. If used in the suspension system the bushing stiffness can be controlled between a soft rate and stiff rate to provide optimum ride comfort and improved handling of the vehicle to be realized.

When in a vehicle as a stabilizer bar bushing, for instance, the bushing of the present invention acts to vary the stabilizer bar efficiency. With the bushing in the soft position the stabilizer bar can articulate without providing wheel rate during single wheeled inputs. This has the effect of improving ride comfort. When additional wheel rate is required as to oppose vehicle roll, the variable compliance mechanism can be controlled by varying the pressure in the voids or chambers to effectively fill the “voids” to provide a stiffer rate to hold the stabilizer bar so it can provide a higher wheel rate.

### BRIEF DESCRIPTION OF THE DRAWINGS

A better understanding of the present invention can be had by referring to the drawings in which;

FIG. 1 is cross-sectional view of a bushing constructed in accordance with the present invention;

FIG. 2 is a cross-sectional view of the bushing taken substantially line at line 2-2 of FIG. 1;

FIG. 3 is an elevational view of the bushings of the present invention in use as a means of mounting a stabilizer bar in a vehicle;

FIG. 4 is an elevational view similar to the view of FIG. 3 but illustrating the bushing being activated to produce movement between the joined parts;

FIG. 5 is an elevational view similar to FIG. 1 but illustrating another preferred embodiment of the present invention: and

FIG. 6 is a cross-sectional view taken substantially along line 6-6 of FIG. 5.

### DETAILED DESCRIPTION OF THE PREFERRED EMBODIMENTS

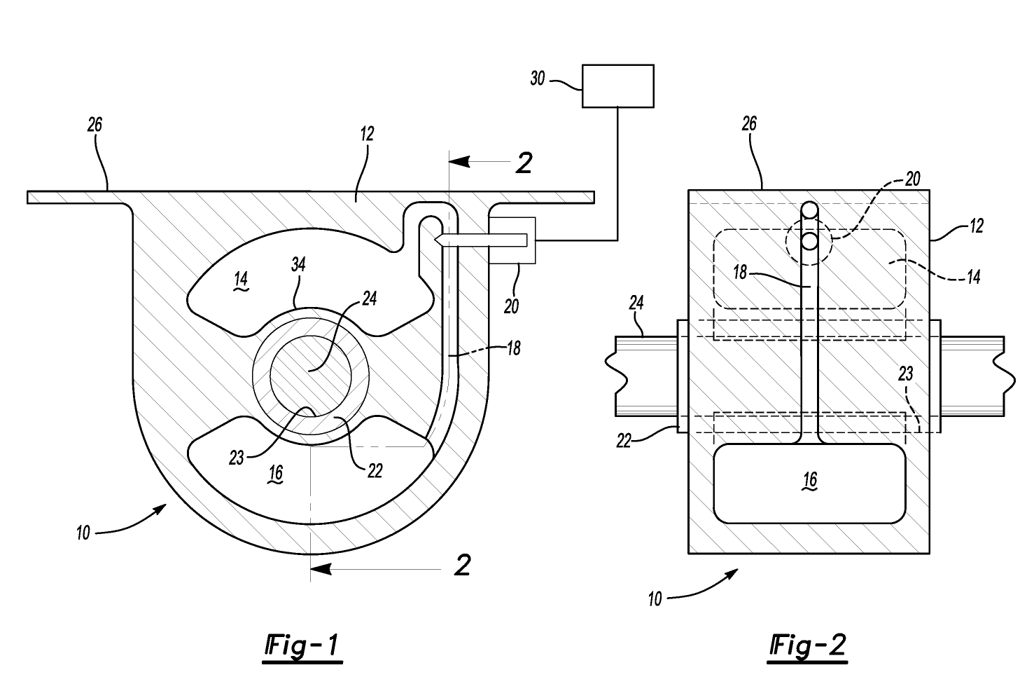

Referring to FIGS. 1 and 2, a variable compliance bushing shown generally at reference numeral 10 includes a housing 12 having a first void or chamber 14 and a second void or chamber 16. A passage 18 formed in the housing 12 connects the chambers 14 and 16 and a solenoid 20 regulates flow of a liquid or gas into the passage 18 and thus into the chambers 14 and 16. If a hydraulic fluid were to be used in the bushing 10 then the solenoid 20 would control the hydraulic pressure in the chambers 14 and 16.

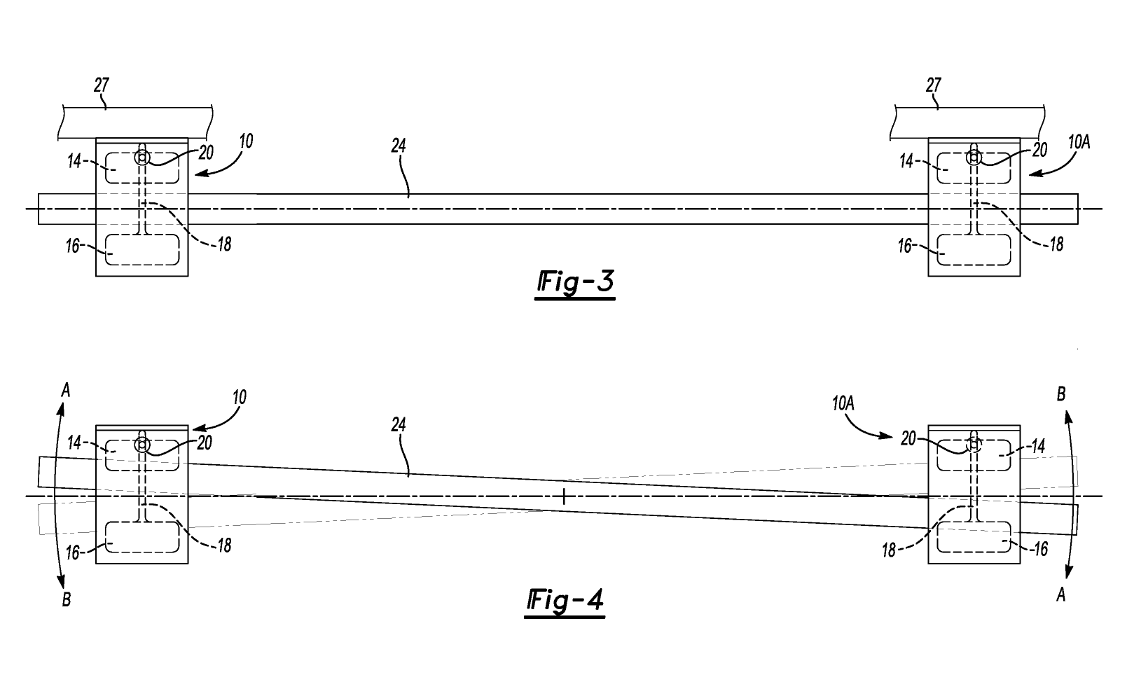

Within the housing 12 is an annular metal ring 22 mounted in an annular through bore 23 which receives a bar 24, or the like, such as a portion of a control arm of a vehicle suspension system. The bar 24 does not have to be part of a control arm but can be any annular part of a motor vehicle that would benefit from the use of the variable compliance bushing 10 disclosed herein. The housing 12 preferably includes a flange 26 which provides the means to mount the bushing 10 to a second part 27 (FIG. 3) such as another component of the motor vehicle suspension system or chassis.

To regulate the stiffness of the connection between the parts 24 and 27 connected by the bushing 10, the solenoid 20 is actuated to control the hydraulic pressure in the chambers 14 and 16. Increased pressure in the chambers 14 and 16 will urge the ring 22 against the bar 24 increasing the stiffness of the connection. The solenoid 20 can be operable by a control means (not shown) which senses road conditions for instance being experienced by a vehicle to regulate the stiffness of the connection of the parts joined by the bushing 10 in response to changed road conditions. A control 30 (FIG. 1) senses vehicle parameters and is electrically connected to the solenoid 20 to control pressure in the chambers 14 and 16. The bushing 10 permits the stiffness of the connection between the parts 24 and 27 to be controlled variably through a range rather than at two distinct levels as in prior art bushings.

Referring now to FIGS. 3 and 4, another use of the variable compliance bushing 10 of the present invention is illustrated wherein the bar 24 is mounted to part 27 between two spaced bushings 10 and 10A to be movable in a first direction A and a second direction B (FIG. 4). To move the bar 24 in direction A the solenoid 20 of bushing 10 is actuated to provide pressure to chamber 16 and solenoid 20 of bushing 10A is actuated to provide pressure to chamber 14. To move the bar 24 in direction B pressure is applied to the chambers 14 and 16 of bushings 10 and 10A respectively. It has been found that bushings 10 and 10A can be controlled as indicated to permit the bar 24 to rotate +/−10 degrees.

Depending upon the desired driving and/or handling characteristics of a particular motor vehicle as sensed by control 30 (FIG. 1), the solenoids 20 control the rate of fluid pressure in the chambers 14 and 16. In this manner, the dampening and/or stiffening rate of a bushing 10 or a pair of bushings 10 and 10A is controlled in a variable manner.

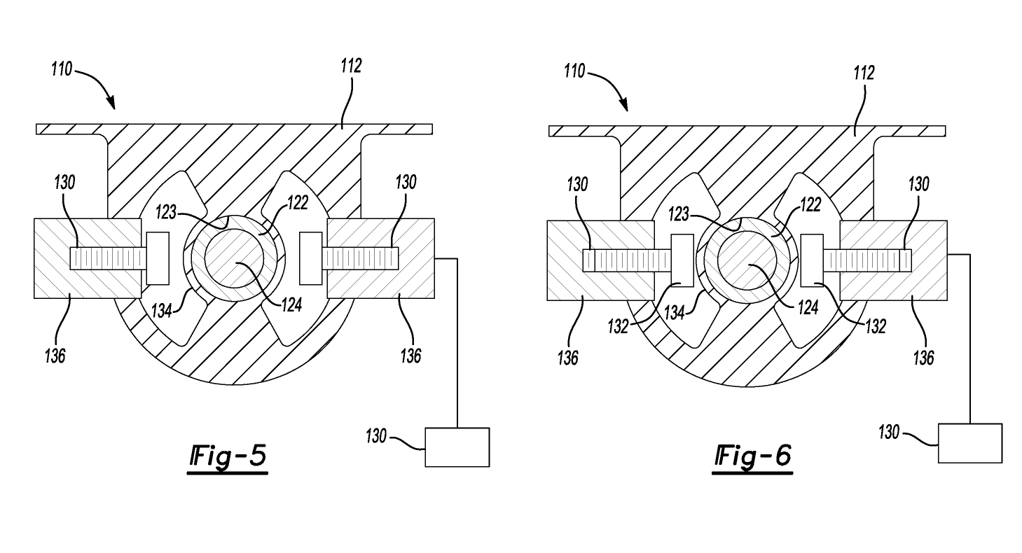

Now referring to FIGS. 5 and 6 a bushing 110 is illustrated as being similar in construction to the embodiment shown in FIGS. 1-4 except unlike the bushing 10 where the stiffness of the joint is controlled hydraulically the stiffness of the joint produced by the bushing 110 is controlled by eclectically actuated mechanical means. The bushing 110 includes a housing 112 in which are provided chambers or voids 114 and 116 on opposite sides of an inner annular ring 122 mounted in through bore 123 and adapted to receive a bar 124 to provide the joint or connection with a part (not shown) attached to the flange 126 of the housing 112.

To variably apply pressure to the ring 122 to thereby vary the stiffness of the connection between the ring 122 and bar 24 electrically actuated screws 130 are mounted in the housing 112 on opposing sides of the ring 122. Each of the screws 130 includes a head 132 which is movable as the screw 130 is rotated to move between a position in which the head 132 is in engagement with an inner portion 134 of the housing 112 surrounding the ring 122 as shown in FIG. 6 and a position in which the head 132 is spaced well away from the portion 134 as seen in FIG. 5. An electrical actuator 136 is provided to selectively move each screw 130. As with the bushing 10 control means 130 can be provided to control the actuator 136 in response to road conditions or other sensed conditions when the bushing 110 is used in a vehicle. Although only a single control means 130 is shown it should be understood that each of the screws 130 would require connection to a control 130 to move the screw 130 in response to sensed vehicle conditions.

Moving the screws 130 toward the portion 134 of the housing 112 increases the stiffness of the joint by increasing the pressure on the ring 122 and moving the screws 130 away from the portion 134 of the housing 112 relaxes the pressure on the ring 122 and reduces the stiffness of the joint produced by the bushing 110.

It should be apparent that the variable compliance bushings 10 and 110 could be regulated to vary the pressure on the ring 22 and 122 the inner metal element 200 to increase or decrease stiffness or dampening rate. This variation is accomplished through the use of the hydraulic pressure in the chambers 14 and 16 within the bushing 10 and by movement of the screws 130 in the embodiment of FIGS. 5 and 6. In addition, the variance compliance bushings 10 and 110 of the present invention can be used to vary both suspension kinematics and compliance by impeding, or allowing, a compliance toe/camber/caster change if used in a vehicle suspension system. By varying the pressure on the ring 22 or ring 122 to vary the stiffness or dampening rate, significant increases in ride comfort and improved handling can be afforded.

When used as arm and link bushings, kinematics toe and camber can be affected by the variable compliance bushings 10 and 110. In addition, the transition between the soft and stiffer rates of the bushings 10 and 110 can be adjusted to improve vehicle dynamics response, especially linearity of yaw and roll. The stiffness or dampening rate of the joint formed by the bushing 10 or 110 can also be varied relative to vehicle loading and driving conditions. Thus, the existence of heavy loads, or trailers being towed, or responses to other vehicle active or semi-active systems can be sensed by the control 30 to alter the state of the bushing 10 and 110 to improve vehicle performance and dynamic response.

When applied in a stabilizer bar bushing, the variable compliance bushing 10 provides for varying the stabilizer bar efficiency. The variable compliance bushing 10 of the present invention permits stabilizer bar to articulate without providing wheel rate during single wheeled inputs. This provides improved ride comfort. When additional wheel rate is required, for example to oppose vehicle roll, the variable compliance bushing 10 provides a stiffer rate to hold the stabilizer bar so that it can provide wheel rate.

It should be apparent that inputs that can be used to control the variable compliance bushing 10 and 110 in vehicle applications are those similar to active suspension inputs, illustratively including steering wheel angle, steering wheel rate, roll angle, roll rate, yaw rate, vehicle speed, throttle position, suspension height and combinations thereof. Thus, the variable compliance bushing 10 and 110 affords for: the adjustment to transitional effects of bushings due to vehicle laden and driving conditions; changing of the vehicle under steer character of a vehicle at different speeds or impending/potential rollover conditions, as well as increased wheel articulation in high compliance state-stabilizer bar applications; reduced transmissibility path for vibrations into the passenger compartment when high compliance states are encountered; less stabilizer bar influenced negative ride effects such as head toss, wheel impacts and rolling feeling; and a higher roll stiffness/roll gradient in low compliance state conditions. The inputs used to control the variable compliance suspension bushing 10, 110 can be supplied to the solenoid 20 or to the actuator 136 by an external control 30 which may or may not be integral with the original equipment control system. In this manner, a variable compliance bushing is provided wherein the ride comfort and handling characteristics of a motor vehicle are enhanced.

It should be apparent that although the bushings 10 and 110 have been described as being especially useful in vehicle applications the bushings could be used as well in other situations where a variation in the stiffness of the joint between two structural members is desired. In such an arrangement reference numeral 24 would be the first structure and reference numeral 27 would be the second structure.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

We claim:

1. A bushing for joining together a first part of a vehicle to second part of said vehicle, said bushing comprising
a) a housing with a through bore adapted to receive said first part and adapted to be attached to said second part;
b) said housing having a first chamber and a second chamber, said chambers being disposed about said through bore;
c) means disposed within said chambers to vary the pressure exerted on said first part to thereby vary the stiffness of the joint formed between said first part and said second part.

2. The bushing as defined in claim 1 and in which said means comprises a control for regulating fluid pressure in said chambers in response to sensed vehicle conditions.

3. The bushing as defined in claim 1 and in which said means comprises a screw carried in each of said chambers,
a) said screws being movable in a direction toward an away from said through bore;
b) control means to move said screws in said chambers in response to sensed vehicle conditions.

4. The bushing as defined in claim 1 and including a second bushing mounted to said first and second vehicle parts at a spaced distance from said first bushing; and wherein said means is operable to vary the pressure in said chambers of each of said bushings to produce a rotational movement of said first part.

5. The bushing as defined in claim 1 and in which said first part is a stabilizer bar for a vehicle

6. A bushing for joining together a first structure to a second structure of said bushing comprising
a) a housing with a through bore adapted to receive said first part and adapted to be attached to said second part;
b) said housing having a first chamber and a second chamber, said chambers being disposed about said through bore;
c) means disposed within said chambers to vary the pressure exerted on said first structure part to thereby vary the stiffness of the joint formed between said first structure and said second structure.

7. The bushing as defined in claim 6 and in which said means comprises a control for regulating fluid pressure in said chambers in response to the sensed need to change the stiffness of the joint formed between said structure and said second structure.

8. The bushing as defined in claim 6 and in which said means comprises a screw carried in each of said chambers,
a) said screws being movable in a direction toward an away from said through bore;
b) control means to move said screws in said chambers in response to sensed need to change the stiffness of the joint formed between said first structure and said second structure.

9. The bushing as defined in claim 6 and including a second bushing mounted to said first and second structures at a spaced distance from said first bushing; and wherein said means is operable to vary the pressure in said chambers of each of said bushings to produce a rotational movement of said first structure.

10. The bushing as defined in claim 9 and in which said first part is a stabilizer bar for a vehicle
